(19) United States
(12) Patent Application Publication
(10) Pub. No.: US 2016/0112358 A1
(43) Pub. Date: Apr. 21, 2016

(54) APPARATUS AND METHOD FOR INTELLIGENT SUPPRESSION OF INCOMING MULTI-FORMAT MULTI-PROTOCOL COMMUNICATIONS

(71) Applicant: Entefy Inc., Palo Alto, CA (US)

(72) Inventors: Alston Ghafourifar, Los Altos Hills, CA (US); Mehdi Ghafourifar, Los Altos Hills, CA (US); Brienne Ghafourifar, Los Altos Hills, CA (US)

(21) Appl. No.: 14/985,820

(22) Filed: Dec. 31, 2015

Related U.S. Application Data
(63) Continuation-in-part of application No. 14/168,815, filed on Jan. 30, 2014.

(51) Int. Cl. H04L 12/58

(52) U.S. Cl. CPC H04L 51/12; H04L 51/24

(57) ABSTRACT

This disclosure relates generally to apparatuses, methods, and computer readable media for integrating communications for computing devices across multiple formats and multiple protocols. More particularly, this disclosure relates to apparatuses, methods, and computer readable media to permit computing devices, e.g., smartphones, tablets, lappets, wearable devices, and the like, to present users with a multi-protocol, person-centric, multi-format in box feed system for integrating multi-format communications. Use of a person-centric, e.g., sender-specific, in box feed allows users to view/preview all their messages in a single feed. Grouping messages by sender also conveniently allows the user to stay on the same user interface screen while reviewing messages and allows for quick visual filtering of messages. “Intelligently Snoozing” messages, e.g., by sender or group of senders, may further allow the user to receive communications at times, locations, on devices, and in ways of the user's choosing.

### CROSS REFERENCE TO RELATED APPLICATIONS

This application is a continuation-in-part to the commonly-assigned and co-pending nonprovisional patent application having U.S. patent application Ser. No. 14/168,815, filed Jan. 30, 2014, and entitled, “Apparatus and Method for Multi-Format Communication Integration” (“the '815 application”). The '815 application is also hereby incorporated by reference in its entirety.

### TECHNICAL FIELD

This disclosure relates generally to apparatuses, methods, and computer readable media for integrating communications for computing devices across multiple communications formats and protocols.

### BACKGROUND

The proliferation of personal computing devices in recent years, especially mobile personal computing devices, combined with a growth in the number of widely-used communications formats (e.g., text, voice, video, image) and protocols (e.g., SMTP, IMAP/POP, SMS/MMS, XMPP, etc.) has led to a communications experience that many users find fragmented and restrictive. Users desire the freedom to communicate anything with anyone, anytime and in any format or protocol they desire.

With current communications technologies, conversations remain “siloed” within particular communications formats or protocols, leading to users having to keep up with multiple conversations in multiple places and across multiple applications on their computing devices, often resulting in inefficient communications and even lost business or personal opportunities. For example, a conversation between two people may begin over text messages (e.g., SMS) while the people are away from their work computers, and then transition to email once they have arrived at their offices. At that point, the entire conversation can no longer be tracked, reviewed, searched, or archived by any single source since it had ‘crossed over’ protocols.

Further, current communications inboxes are typically either subject-people-centric (i.e., grouped by both subject line and sender), subject-centric (i.e., grouped by subject line only), or format-centric (i.e., grouped together by message format). What is needed is a multi-protocol, person-centric, multi-format in box feed system for integrating multi-format communications. Such a solution may provide various potential benefits to users of such a system, including: presenting email, text, voice, video, and social messages all grouped/categorized by contact (i.e., ‘person-centric’); providing several potential filtering options to allow for traditional sorting of communications (e.g., an ‘email’ view for displaying only emails); displaying such information in a screen-optimized feed format; and allowing a user to control how, when, and who they interact with—on a message-, message group-, channel-, device-, or even contact-level basis, (e.g., by intelligently suppressing or “snoozing” such interactions via direct user action and/or via learned behavior patterns determined by the communication system itself). Importantly, centralization of messages by contact may be employed to better help users manage the volume (and rate) of incoming messages in any format and via any protocol—and to save precious screen space on mobile devices (e.g., such a display has empirically been found to be up to six to seven times more efficient that a traditional in box format). Further, in similar measure, such an in box feed makes it easier for a user to delete, block, delay, or take other actions on messages or groups of messages (e.g., all messages from a particular contact or person, spam, or graymail).

The subject matter of the present disclosure is directed to overcoming, or at least reducing the effects of, one or more of the problems set forth above. To address these and other issues, techniques that enable seamless, multi-format, multi-protocol communications via a single user interface are described herein.

### BRIEF DESCRIPTION OF THE DRAWINGS

FIG. 1A is a block diagram illustrating a server-entry point network architecture infrastructure, according to one or more disclosed embodiments.

FIG. 1B is a block diagram illustrating a client-entry point network architecture infrastructure, according to one or more disclosed embodiments.

FIG. 2A is a block diagram illustrating a computer which could be used to execute the multi-format/multi-protocol communication optimization approaches described herein according to one or more of disclosed embodiments.

FIG. 2B is a block diagram illustrating a processor core, which may reside on a computer according to one or more of disclosed embodiments.

FIG. 3A shows an example of a multi-protocol, person-centric, multi-format in box feed, according to one or more disclosed embodiments.

FIG. 3B shows an example of a multi-protocol, multi-format in box feed for messages to and from a particular user, according to one or more disclosed embodiments.

FIG. 3C shows an example of a preview pane for a multi-protocol, multi-format in box feed for messages to and from a particular user, according to one or more disclosed embodiments.

FIG. 3D shows an example of a document repository page for a particular user, according to one or more disclosed embodiments.

FIG. 3E shows an example of a multi-protocol, multi-format communication composition user interface, according to one or more disclosed embodiments.

FIG. 4 is a flowchart of one embodiment of a method for populating a multi-protocol, person-centric, multi-format in box feed, according to one or more disclosed embodiments.

FIG. 5 is a flowchart of one embodiment of a method for processing a user interface-driven query, according to one or more disclosed embodiments.

FIG. 6 is a flowchart of one embodiment of a method for creating a multi-protocol, multi-format communication transmission, according to one or more disclosed embodiments.

FIG. 7 is a block diagram of one embodiment of a Universal Message Object, according to one or more disclosed embodiments.

FIG. 8 is a flowchart of one embodiment of a method for intelligently suppressing notifications from a person, according to one or more disclosed embodiments.

### DETAILED DESCRIPTION

Disclosed are apparatuses, methods, and computer readable media for integrating communications for computing devices across multiple formats and multiple protocols. More particularly, but not by way of limitation, this disclosure relates to apparatuses, methods, and computer readable media to permit computing devices, e.g., smartphones, tablets, lappets, wearable devices, and the like, to present users with a multi-protocol, person-centric, multi-format in box feed system for integrating multiple formats and protocols of communication.

Use of a person-centric, e.g., sender-specific, in box feed allows users to view/preview all their messages in a single feed. Grouping messages by sender also conveniently allows the user to stay on the same user interface screen while reviewing messages and allows for quick visual filtering of messages. Such a multi-format communication feed may also include one or more of a variety of communication formats including text, voice, video, and/or images. Further, the use of certain gestures and icon features may help the user with the decision-making process regarding the choice to reply, delay replying (including the time delaying of replies across multiple protocols), delay the receipt of incoming communication notifications, delete, mark as spam, see a full message, translate, read, or flag a message as being unread.

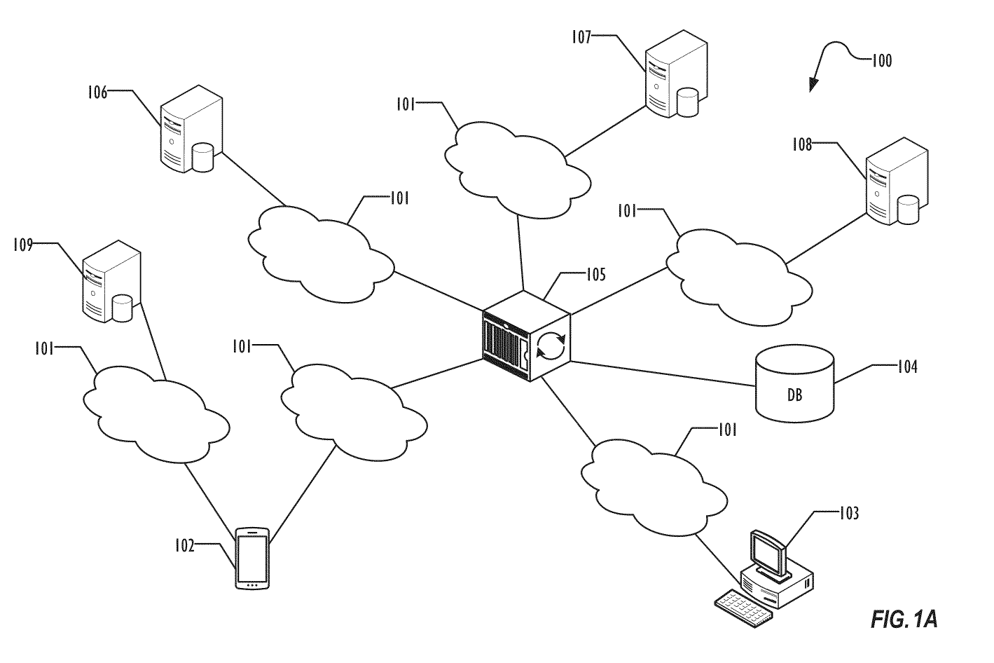

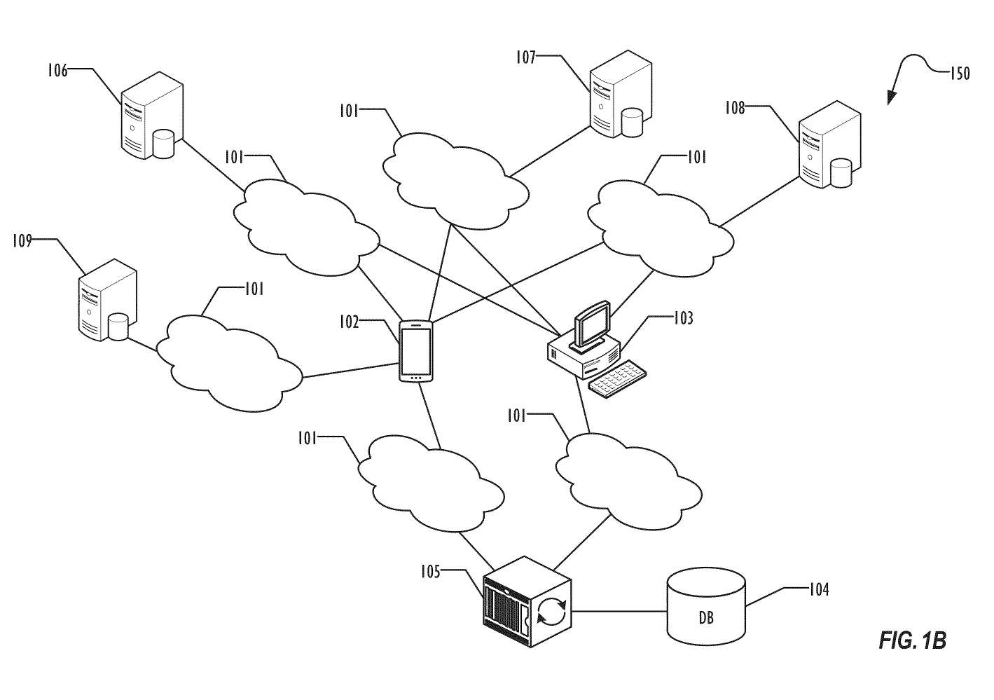

Referring now to FIG. 1A, a server-entry point network architecture infrastructure 100 is shown schematically. Infrastructure 100 contains computer networks 101. Computer networks 101 include many different types of computer networks available today, such as the Internet, a corporate network, or a Local Area Network (LAN). Each of these networks can contain wired or wireless devices and operate using any number of network protocols (e.g., TCP/IP). Networks 101 may be connected to various gateways and routers, connecting various machines to one another, represented, e.g., by sync server 105, end user computers 103, mobile phones 102, and computer servers 106-109. In some embodiments, end user computers 103 may not be capable of receiving SMS text messages, whereas mobile phones 102 are capable of receiving SMS text messages. Also shown in infrastructure 100 is a cellular network 101 for use with mobile communication devices. As is known in the art, mobile cellular networks support mobile phones and many other types of devices (e.g., tablet computers not shown). Mobile devices in the infrastructure 100 are illustrated as mobile phone 102. Sync server 105, in connection with database(s) 104, may serve as the central “brains” and data repository, respectively, for the multi-protocol, multi-format communication composition and in box feed system to be described herein. In the server-entry point network architecture infrastructure 100 of FIG. 1A, centralized sync server 105 may be responsible for querying and obtaining all the messages from the various communication sources for individual users of the system and keeping the multi-protocol, multi-format in box feed for a particular user of the system synchronized with the data on the various third party communication servers that the system is in communication with. Database(s) 104 may be used to store local copies of messages sent and received by users of the system, as well as individual documents associated with a particular user, which may or may not also be associated with particular communications of the users. As such, the database portion allotted to a particular user will contain a record of all communications in any form to and from the user.

Server 106 in the server-entry point network architecture infrastructure 100 of FIG. 1A represents a third party email server (e.g., a GOOGLE® or YAHOO!® email server). (GOOGLE is a registered service mark of Google Inc. YAHOO! is a registered service mark of Yahoo! Inc.) Third party email server 106 may be periodically pinged by sync server 105 to determine whether particular users of the multi-protocol, multi-format communication composition and in box feed system described herein have received any new email messages via the particular third-party email services. Server 107 represents a represents a third party instant message server (e.g., a YAHOO!® Messenger or AOL® Instant Messaging server). (AOL is a registered service mark of AOL Inc.) Third party instant messaging server 107 may also be periodically pinged by sync server 105 to determine whether particular users of the multi-protocol, multi-format communication composition and in box feed system described herein have received any new instant messages via the particular third-party instant messaging services. Similarly, server 108 represents a third party social network server (e.g., a FACEBOOK® or TWITTER® server). (FACEBOOK is a registered trademark of Facebook, Inc. TWITTER is a registered service mark of Twitter, Inc.) Third party social network server 108 may also be periodically pinged by sync server 105 to determine whether particular users of the multi-protocol, multi-format communication composition and in box feed system described herein have received any new social network messages via the particular third-party social network services. It is to be understood that, in a “push-based” system, third party servers may push notifications to sync server 105 directly, thus eliminating the need for sync server 105 to periodically ping the third party servers. Finally, server 109 represents a cellular service provider's server. Such servers may be used to manage the sending and receiving of messages (e.g., email or SMS text messages) to users of mobile devices on the provider's cellular network. Cellular service provider servers may also be used: 1) to provide geo-fencing for location and movement determination; 2) for data transference; and/or 3) for live telephony (i.e., actually answering and making phone calls with a user's client device). In situations where two ‘on-network’ users are communicating with one another via the multi-protocol, multi-format communication system itself, such communications may occur entirely via sync server 105, and third party servers 106-109 may not need to be contacted.

Referring now to FIG. 1B, a client-entry point network architecture infrastructure 150 is shown schematically. Similar to infrastructure 100 shown in FIG. 1A, infrastructure 150 contains computer networks 101. Computer networks 101 may again include many different types of computer networks available today, such as the Internet, a corporate network, or a Local Area Network (LAN). However, unlike the server-centric infrastructure 100 shown in FIG. 1A, infrastructure 150 is a client-centric architecture. Thus, individual client devices, such as end user computers 103 and mobile phones 102 may be used to query the various third party computer servers 106-109 to retrieve the various third party email, IM, social network, and other messages for the user of the client device. Such a system has the benefit that there may be less delay in receiving messages than in a system where a central server is responsible for authorizing and pulling communications for many users simultaneously. Also, a client-entry point system may place less storage and processing responsibilities on the central multi-protocol, multi-format communication composition and in box feed system's server computers since the various tasks may be distributed over a large number of client devices. Further, a client-entry point system may lend itself well to a true, “zero knowledge” privacy enforcement scheme. In infrastructure 150, the client devices may also be connected via the network to the central sync server 105 and database 104. For example, central sync server 105 and database 104 may be used by the client devices to reduce the amount of storage space needed on-board the client devices to store communications-related content and/or to keep all of a user's devices synchronized with the latest communication-related information and content related to the user. It is to be understood that, in a “push-based” system, third party servers may push notifications to end user computers 102 and mobile phones 103 directly, thus eliminating the need for these devices to periodically ping the third party servers.

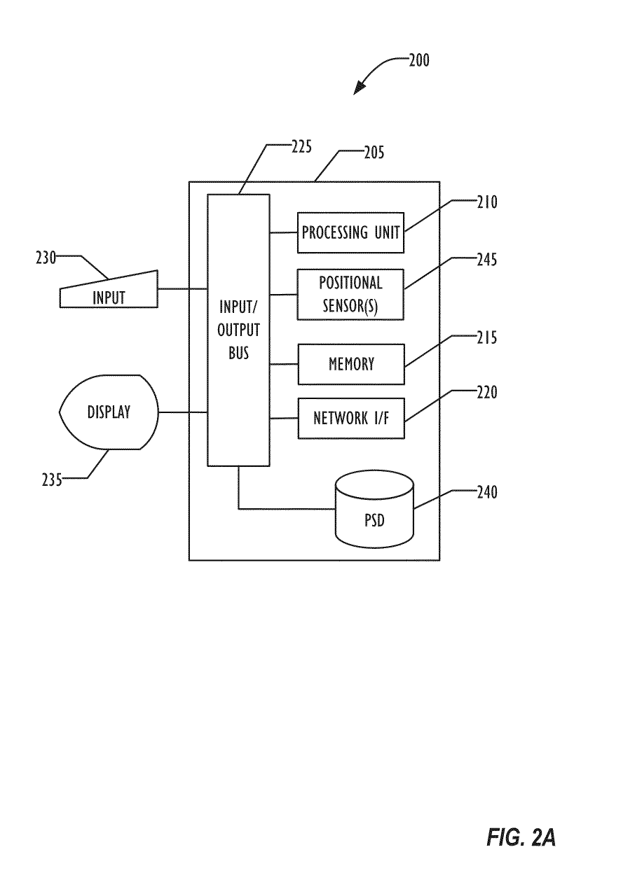

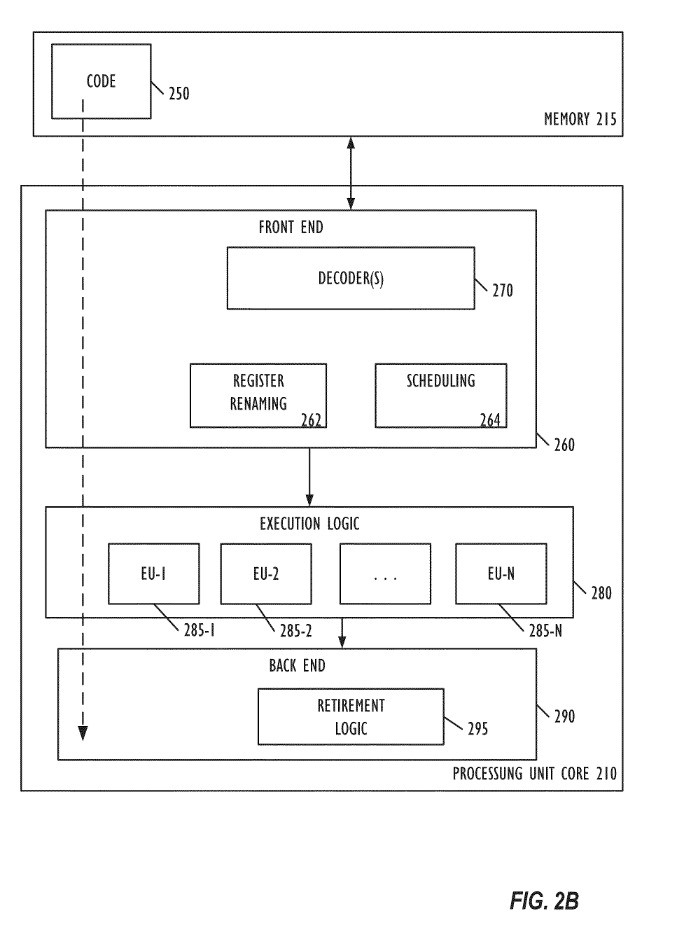

Referring now to FIG. 2A, an example processing device 200 for use in the communication systems described herein according to one embodiment is illustrated in block diagram form. Processing device 200 may serve in, e.g., a mobile phone 102, end user computer 103, sync server 105, or a server computer 106-109. Example processing device 200 comprises a system unit 205 which may be optionally connected to an input device 230 (e.g., keyboard, mouse, touch screen, etc.) and display 235. A program storage device (PSD) 240 (sometimes referred to as a hard disk, flash memory, or non-transitory computer readable medium) is included with the system unit 205. Also included with system unit 205 may be a network interface 220 for communication via a network (either cellular or computer) with other mobile and/or embedded devices (not shown). Network interface 220 may be included within system unit 205 or be external to system unit 205. In either case, system unit 205 will be communicatively coupled to network interface 220. Program storage device 240 represents any form of non-volatile storage including, but not limited to, all forms of optical and magnetic memory, including solid-state storage elements, including removable media, and may be included within system unit 205 or be external to system unit 205. Program storage device 240 may be used for storage of software to control system unit 205, data for use by the processing device 200, or both.

System unit 205 may be programmed to perform methods in accordance with this disclosure. System unit 205 comprises one or more processing units, input-output (I/O) bus 225 and memory 215. Access to memory 215 can be accomplished using the communication bus 225. Processing unit 210 may include any programmable controller device including, for example, a mainframe processor, a mobile phone processor, or, as examples, one or more members of the INTEL® ATOM™, INTEL® XEON™, and INTEL® CORE™ processor families from Intel Corporation and the Cortex and ARM processor families from ARM. (INTEL, INTEL ATOM, XEON, and CORE are trademarks of the Intel Corporation. CORTEX is a registered trademark of the ARM Limited Corporation. ARM is a registered trademark of the ARM Limited Company). Memory 215 may include one or more memory modules and comprise random access memory (RAM), read only memory (ROM), programmable read only memory (PROM), programmable read-write memory, and solid-state memory. As also shown in FIG. 2A, system unit 205 may also include one or more positional sensors 245, which may comprise an accelerometer, gyrometer, global positioning system (GPS) device, or the like, and which may be used to track the movement of user client devices.

Referring now to FIG. 2B, a processing unit core 210 is illustrated in further detail, according to one embodiment. Processing unit core 210 may be the core for any type of processor, such as a micro-processor, an embedded processor, a digital signal processor (DSP), a network processor, or other device to execute code. Although only one processing unit core 210 is illustrated in FIG. 2B, a processing element may alternatively include more than one of the processing unit core 210 illustrated in FIG. 2B. Processing unit core 210 may be a single-threaded core or, for at least one embodiment, the processing unit core 210 may be multithreaded, in that, it may include more than one hardware thread context (or “logical processor”) per core.

FIG. 2B also illustrates a memory 215 coupled to the processing unit core 210. The memory 215 may be any of a wide variety of memories (including various layers of memory hierarchy), as are known or otherwise available to those of skill in the art. The memory 215 may include one or more code instruction(s) 250 to be executed by the processing unit core 210. The processing unit core 210 follows a program sequence of instructions indicated by the code 250. Each instruction enters a front end portion 260 and is processed by one or more decoders 270. The decoder may generate as its output a micro operation such as a fixed width micro operation in a predefined format, or may generate other instructions, microinstructions, or control signals which reflect the original code instruction. The front end 260 may also include register renaming logic 262 and scheduling logic 264, which generally allocate resources and queue the operation corresponding to the convert instruction for execution.

The processing unit core 210 is shown including execution logic 280 having a set of execution units 285-1 through 285-N. Some embodiments may include a number of execution units dedicated to specific functions or sets of functions. Other embodiments may include only one execution unit or one execution unit that can perform a particular function. The execution logic 280 performs the operations specified by code instructions.

After completion of execution of the operations specified by the code instructions, back end logic 290 retires the instructions of the code 250. In one embodiment, the processing unit core 210 allows out of order execution but requires in order retirement of instructions. Retirement logic 295 may take a variety of forms as known to those of skill in the art (e.g., re-order buffers or the like). In this manner, the processing unit core 210 is transformed during execution of the code 250, at least in terms of the output generated by the decoder, the hardware registers and tables utilized by the register renaming logic 262, and any registers (not shown) modified by the execution logic 280.

Although not illustrated in FIG. 2B, a processing element may include other elements on chip with the processing unit core 210. For example, a processing element may include memory control logic along with the processing unit core 210. The processing element may include I/O control logic and/or may include I/O control logic integrated with memory control logic. The processing element may also include one or more caches.

Multi-Protocol, Multi-Format In box Feed

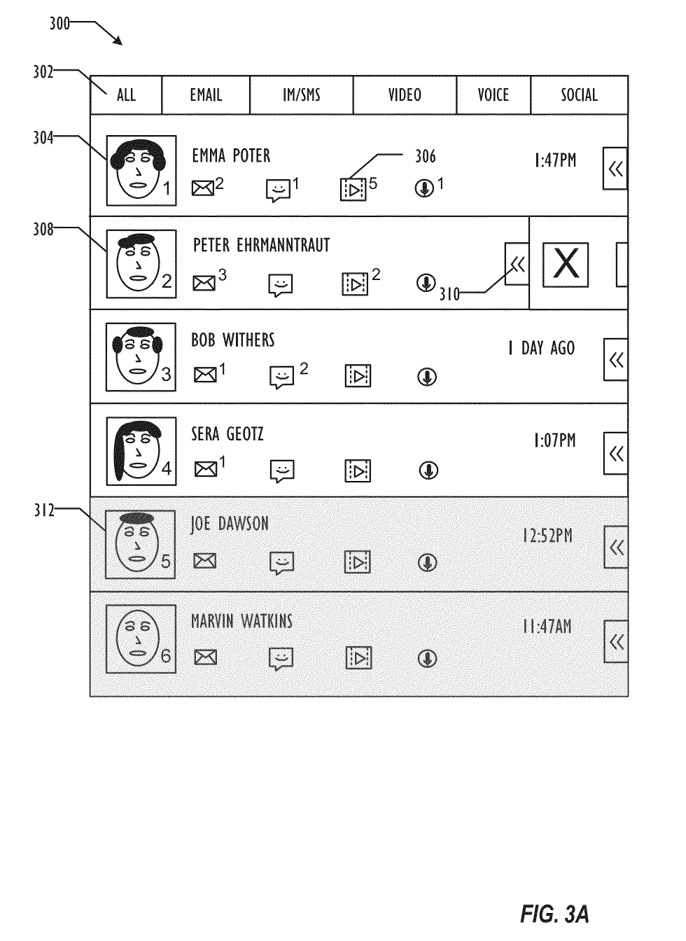

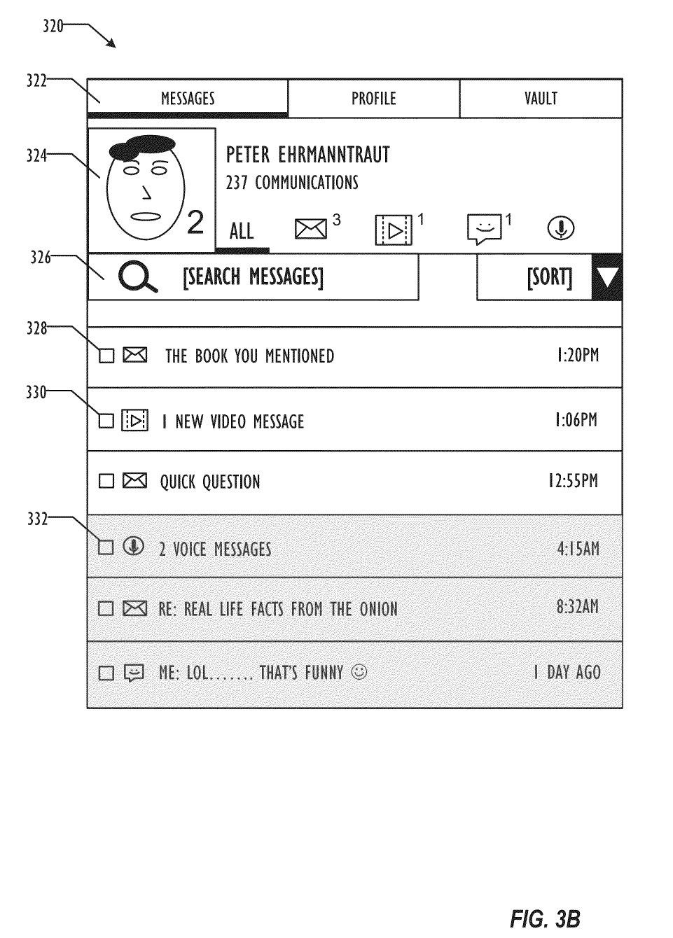

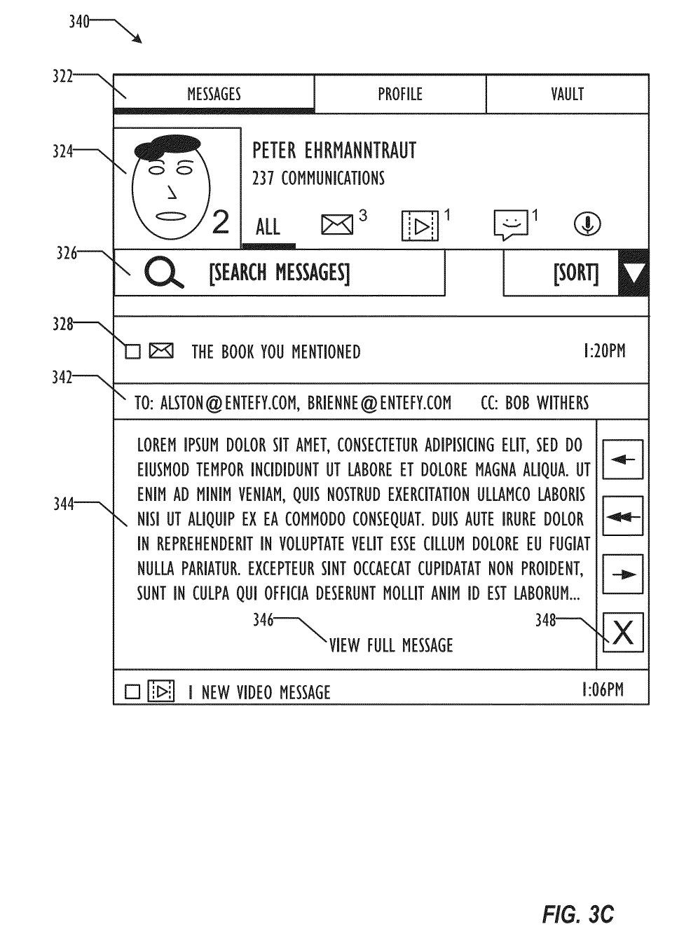

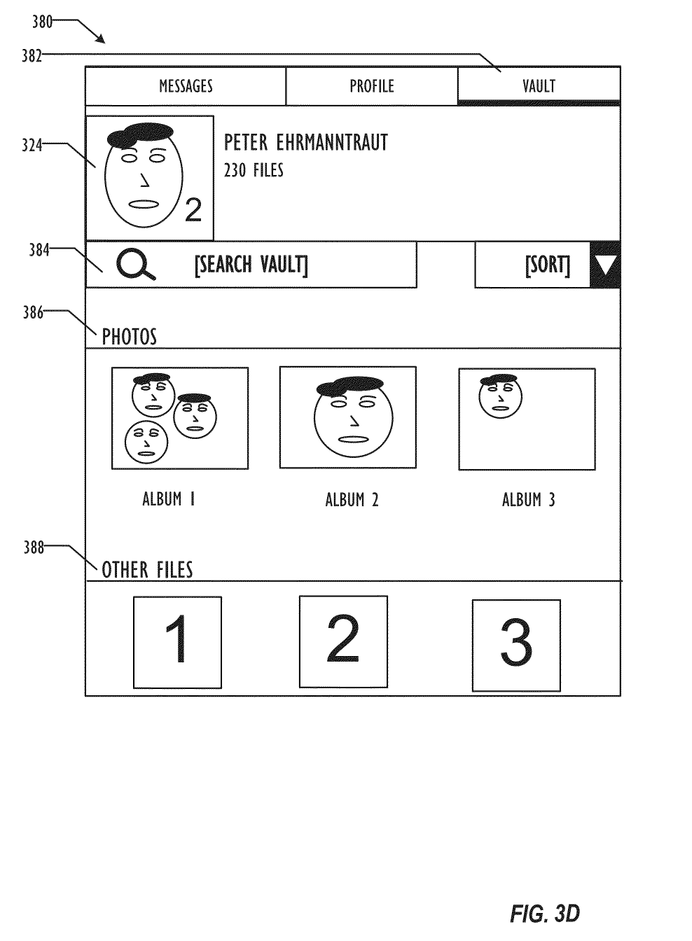

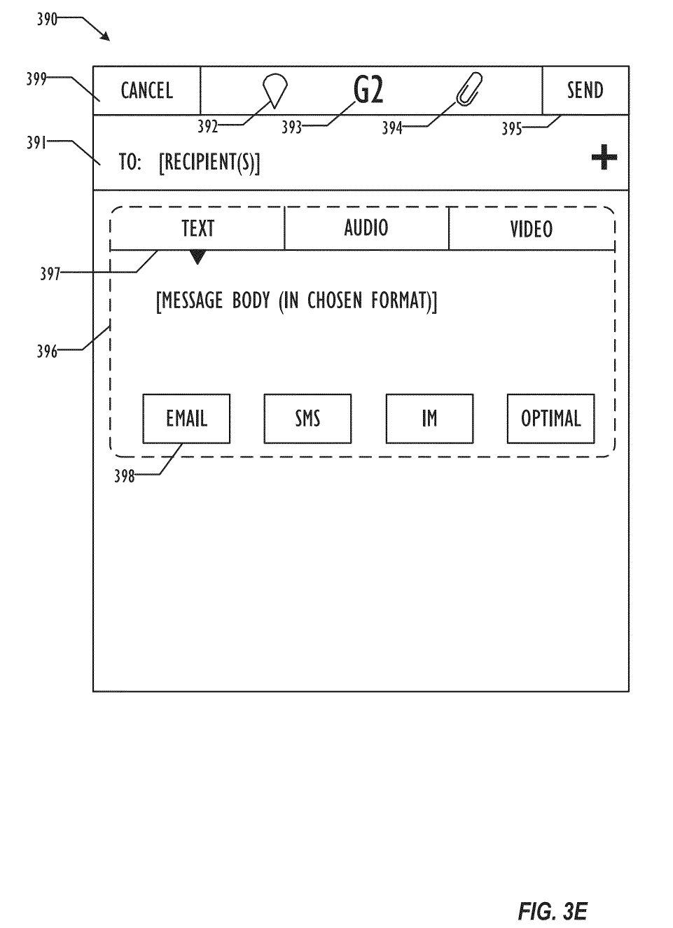

FIG. 3A shows an example of a multi-protocol, person-centric, multi-format in box feed 300, according to one or more disclosed embodiments. The in box feed 300 shown in FIG. 3A may, e.g., be displayed on the display of a mobile phone, laptop computer, or other computing device. In certain embodiments, elements of in box feed 300 may be interacted with by a user utilizing a touchscreen interface or any other suitable input interface.

As is shown across the top row of the interface 302, the multi-format, multi-protocol messages received by a user of the system may be grouped by protocol (e.g., Email, IM/SMS, Video, Voice, etc.), or all messages may be combined together into a single, unified in box feed, as is shown in FIG. 3A. Row 304 in the example of FIG. 3A represents the first “person-centric” message row in the user's unified in box feed. As shown in FIG. 3A, the pictorial icon and name of the sender whose messages are listed in row 304 appear at the beginning of the row. The pictorial icon and sender name indicate to the user of the system that all messages that have been aggregated in row 304 are from exemplary user ‘Emma Poter.’ Note that any indication of sender may be used. Also present in row 304 are several graphical icons 306 that represent links to messages of different types that have been received from Emma Poter. For example, Emma Poter has sent the particular user whose in box feed is shown in FIG. 3A two email messages, one instant message, five video messages, and one voice message. The user interface may utilize icons, as is shown in FIG. 3A, or it may use any other suitable form of indication, such as text, grids, charts, or any other form of personalized identification. The types of messages/communication used in the in box feed may be selected or personalized, as well. The timestamp (e.g., 1:47 pm in row 304) may be used to indicate the time at which the most recently-received message has been received from a particular sender.

Moving down to row 308 of in box feed 300, messages from a second user, Peter Ehrmanntraut, have also been aggregated into a single row of the feed. As is displayed on the right hand side of row 308 is reveal arrow 310. Selection of reveal arrow 310 may provide additional options to the user such as to reply, delay reply/delay send, forward, return a call, favorite, archive, or delete certain message from a particular sender. Further, the reveal action may conveniently keep the user on the same screen and allows for quick visual filtering of messages. Gestures and icon features may help the user with the decision-making process regarding the choice to reply, delay replying (including the time delaying of response across multiple protocols), delete, mark as spam, see a full message, translate, read, or flag a message as being unread. With respect to the “delay reply/delay send” option, the multi-protocol, multi-format communication system may determine, based on the determined outgoing message format and protocol, that a particular communication in a particular format (or that is being sent via a particular protocol) should be delayed before being sent to the recipient. For example, a video or voice message may not be appropriate to send at midnight, and so the system may delay sending the message until such time as the recipient is more likely to be awake, e.g., 9:00 am. On the other hand, the outgoing message is in text format and being delivered via the SMS protocol, sending the message at midnight may be more socially-appropriate. Delay reply/delay send may also take into account the time zone of the recipient and choose a more socially-appropriate delivery time for a message based on the recipient's local time.

Finally, moving down to row 312, the ‘grayed-out’ characteristic of the row may be used to indicate that there are no remaining unread/unopened messages of any format or protocol type remaining from a particular sender. Alternately, each message type may be individually grayed out, indicating that there are no new messages of a particular type. It is to be understood that the use of a grayed out row is merely exemplary, and that any number of visual indicators may be used to inform the user of the device that no unread messages remain.

As may now be appreciated, the multi-protocol, person-centric, multi-format in box feed 300 of FIG. 3A may provide various potential benefits to users of such a system, including: presenting email, text, voice, video, and social messages all grouped/categorized by contact (i.e., ‘person-centric,’ and not subject-people-centric, subject-centric, or format-centric); providing several potential filtering options to allow for traditional sorting of communications (e.g., an ‘email’ view for displaying only emails); and displaying such information in a screen-optimized feed format. Importantly, centralization of messages by contact may be employed to better help users manage the volume of incoming messages in any format and to save precious screen space on mobile devices (e.g., such a display has empirically been found to be up to six to seven times more efficient that a traditional in box format). Further, such an in box feed makes it easier for a user to delete unwanted messages or groups of messages (e.g., spam or graymail). The order of appearance in the in box feed may be customized as well. The in box feed may default to showing the most recent messages at the top of the feed. Alternatively, the in box feed may be configured to bring messages from certain identified “VIPs” to the top of the in box feed as soon as any message is received from such a VIP in any format and/or via any protocol. The in box feed may also alert the user, e.g., if an email, voice message, and text have all been received in the last ten minutes from the same person—likely indicating that the person has an urgent message for the user. The in box feed may also identify which companies particular senders are associated with and then organize the in box feed, e.g., by grouping all communications from particular companies together.

In other embodiments, users may also select their preferred delivery method for incoming messages of all types. For example, they can choose to receive their email messages in voice format or voice messages in text, etc.

Referring now to FIG. 3B, an example of a multi-protocol, multi-format in box feed for messages to and from a particular user 320 is shown, according to one or more disclosed embodiments. As is shown across the top row of the interface 322, the messages from a particular user, in this case ‘Peter Ehrmanntraut’ may be displayed in a single multi-format, multi-protocol message feed. Row 322 in the example of FIG. 3B also presents the user with the opportunity to select the particular sender's ‘Messages,’ ‘Profile,’ or ‘Vault’ storage, which is a document repository of files shared between the user and a particular sender (e.g., email attachments, MMS, etc.). As shown in FIG. 3B, the pictorial icon 324 and name of the sender whose messages are listed in interface 320 appear at the top of the communications page. Also present in interface 320 is search icon 326, which may be activated to search across all message formats and protocols (e.g., including voice and video messages) from a particular sender for a particular search term(s) or topic. Message items may also be sorted in the feed by various characteristics such as time of receipt, format, or other content and/or semantic-based ranking schemes. Moving down to the messages portion of interface 320, checkbox 328 represents the first email message received from user Peter Ehrmanntraut, whereas checkbox 330 represents the first new video message from user Peter Ehrmanntraut. Finally, grayed-out checkbox 332 represents an aggregation of voice messages that have already been listened to by the user.

Referring now to FIG. 3C, an example of a preview pane 340 for a multi-protocol, multi-format in box feed for messages to and from a particular user is shown, according to one or more disclosed embodiments. As is displayed in FIG. 3C, the message associated with checkbox 328 has been opened to provide a more in-depth preview of the associated email text. According to some embodiments, the recipients 342 are listed out above the body 344 of the email, and a link 346 may be activated that causes the application to retrieve the full email message from either the system's sync server or third party email servers. The interface may also provide a number of preview quick action buttons 348 to be performed on the message that is being previewed, e.g., reply, reply all, forward, delete, etc.

Referring now to FIG. 3D, an example of a document repository page 380 for a particular user is shown, according to one or more disclosed embodiments. Row 382 in the example of FIG. 3D presents the user with the opportunity to select the particular sender's ‘Vault’ page, which is a document repository of files shared between user and the particular sender (e.g., email attachments, MMS, etc.). As with the messages interface, a searching functionality 384 may be provided, which searches the documents associated with the particular user's Vault. A user's Vault may include multimedia files 386, such as photos, in addition to other files 388, such as word processing and presentation documents.

Multi-Protocol, Multi-Format Communication Composition User Interface

Referring now to FIG. 3E, an example of a multi-protocol, multi-format communication composition user interface 390 is shown, according to one or more disclosed embodiments. The top row of interface 390 in the example of FIG. 3E presents the user with several options related to the composition of a given communication. For instance, icon 392 may provide the user with the ability to geo-tag his or her location onto the message being sent. Icon 393 may be used to indicate that a message has a special status, such as a ‘poll question’ or other ‘request for recommendation’ with a response requested by the sender. Such special status messages may optionally be sent to ‘tiers’ of contacts (e.g., first-tier relationship, second-tier relationships, etc.) or even the general public, as opposed to particular contacts. Icon 394 may be used to attach one or more file attachments to the message being composed, button 399 may be used to cancel the message being composed, and button 395 may be used to send off the message to the one or more recipients specified in the “To:” field 391.

Message box 396 may be used by the user to enter his or her message any desired communications format or protocol that the system is capable of handling. For example, a text message may be entered by activating icon 397 and using an on-screen keyboard or the like. Alternately, an audio message or a video message may be recorded by activating the other icons across the top row of message box 396. Once the message has been composed in the desired format, the user may utilize the row of icons 398 across the bottom of message box 396 to select the desired delivery protocol for the outgoing communication. As shown in FIG. 3E, those protocols may include, e.g., email, SMS/MMS/IM, or Optimal. As may be understood, the selection of desired delivery protocol may necessitate a conversion of the format of the composed message. For example, if a message is entered in audio format, but is to be sent out in a text format, such as via the SMS protocol, the audio from the message would be digitized, analyzed, and converted to text format before sending via SMS (i.e., a speech-to-text conversion). Likewise, if a message is entered in textual format, but is to be sent in voice format, the text from the message will need to be run through a text-to-speech conversion program so that an audio recording of the entered text may be sent to the desired recipients in the selected voice format via the appropriate protocol, e.g., via an email message.

The selection of the “Optimal” delivery option may have several possible implementations. The selection of output message format and protocol may be based on, e.g., the format of the incoming communication, the preferred format or protocol of the recipient and/or sender of the communication (e.g., if the recipient is an ‘on-network’ user who has set up a user profile specifying preferred communications formats and/or protocols), an optimal format or protocol for a given communication session/message (e.g., if the recipient is in an area with a poor service signal, lower bit-rate communication formats, such as text, may be favored over higher bit-rate communications formats, such as video or voice), and/or economic considerations of format/protocol choice to the recipient and/or sender (e.g., if SMS messages would charge the recipient an additional fee from his or her provider, other protocols, such as email, may be chosen instead).

Other considerations may also go into the determination of an optimal delivery option, such as analysis of recent communication volume, analysis of past communication patterns with a particular recipient, analysis of recipient calendar entries, and/or geo-position analysis. Other embodiments of the system may employ a ‘content-based’ determination of delivery format and/or protocol. For example, if an outgoing message is recorded as a video message, SMS may be de-prioritized as a sending protocol, given that text is not an ideal protocol for transmitting video content. Further, natural language processing (NLP) techniques may be employed to determine the overall nature of the message (e.g., a condolence note) and, thereby, assess an appropriate delivery format and/or protocol. For example, the system may determine that a condolence note should not be sent via SMS, but rather translated into email or converted into a voice message. Thus, the techniques disclosed herein allow communications systems to become ‘message-first,’ as opposed to ‘protocol-first,’ eventually allowing consideration of message protocol to fall away entirely for the sender of the communication.

Another beneficial aspect of the multi-protocol, multi-format communication composition system described herein is the ability to allow the user to send one message to the same recipient in multiple formats and/or via multiple protocols at the same time (or with certain formats/protocols time delayed). Likewise, the multi-protocol, multi-format communication composition system also allows the user the ability to send one message to multiple recipients in multiple formats and/or via multiple protocols. The choice of format/protocol for the outgoing message may be made by either the system (i.e., programmatically) or by the user, e.g., by selecting the desired formats/protocols via the user interface of the multi-protocol, multi-format communication composition system.

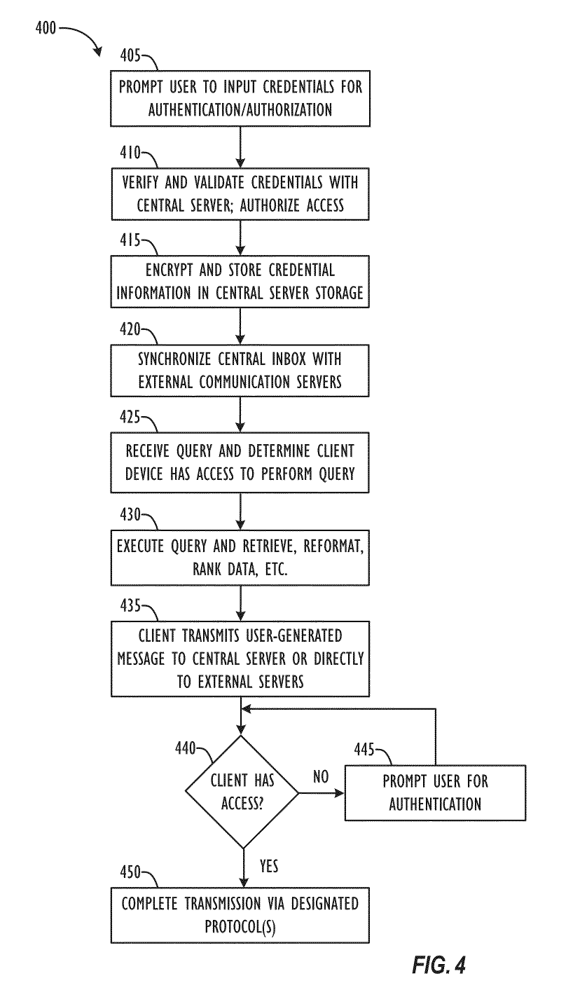

FIG. 4 shows a flowchart 400 of one embodiment of a method for populating a multi-protocol, person-centric, multi-format in box feed, according to one or more disclosed embodiments. First, the system may prompt the user to input his or her credentials so that he or she may be authenticated and authorized (Step 405). Next, the sync server 105 and/or third-party servers 106-109 may verify and validate the user's credentials as being authorized to receive communications associated with a particular account(s) tied to a particular messaging service(s) (Step 410). Next, the user's credentials are encrypted and stored at the sync server 105 so that the user's messages may continue to be retrieved by the system (Step 415). Once the user's credentials have been verified and stored, the system may attempt to synchronize the user's multi-protocol, person-centric, multi-format unified messaging in box feed with the various external communication servers hosting the user's messages from the various third-party messaging services, e.g., by using one or more third-party credentials of the first user stored at the sync server (Step 420). Next, the system may receive a query from a particular user's client device (e.g., to pull new communications directed to the user) and determine that the client device has access to perform the query (Step 425). Assuming the client device has access, the query will be executed, and the results will be retrieved and optionally reformatted, ranked, etc., according to the user's and/or system's preferences (Step 430). One example of a formatted and sorted query result set is shown in the exemplary user interface of FIG. 3A.

When the user desires to transmit a user-generated message, e.g., via the exemplary user interface of FIG. 3E, the process may resume at Step 435 by the client device transmitting the user-generated message either to the system's sync server or directly to the third-party communications servers. At that point, it may again be verified that the client device has access to send the message(s) (Step 440). If the client device does not have access, the user will again be prompted to enter his or her authentication credentials (Step 445). Once proper authentication has been established, the transmission of the user-generated message may be completed via the designated protocol(s). The nature and type of the protocols may be determined, e.g., in accordance with one or more of the various rules and preferences discussed above with reference to FIG. 3E.

User Interface-Driven Search Query Generation

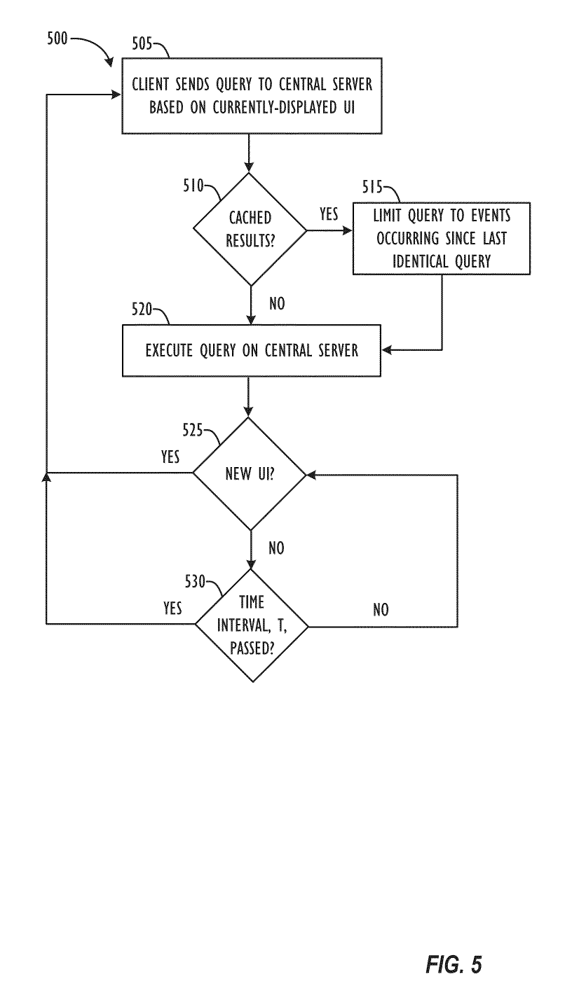

FIG. 5 shows a flowchart 500 of one embodiment of a method for processing a user interface-driven query, according to one or more disclosed embodiments. First, a client device may send a query to a central communications system server, such as sync server 105, based on the status of the currently-displayed user interface (UI) on the client device (Step 505). For example, with respect to the user interface 300 shown in FIG. 3A, the selection of a row in the currently-displayed UI for sender ‘Emma Poter’ could be associated with one or more system-defined “tags” that would be used by the system to generate a query for messages from user ‘Emma Poter.’ Likewise, changing the UI to the ‘Video’ tab in row 302 of user interface 300 would generate a query for only messages in a video format, etc. Next, the system may determine if there are cached results for the query that the client device is currently trying to send (Step 510). If there are cached results at Step 510, the query may be limited to events occurring since the last identical query was issued by the client device (Step 515), and then the limited query may be executed by the central communication system server (Step 520). If there are no cached results at Step 510, then the full query may simply be executed by the central communication system server (Step 520).

After some amount of time, the client device may poll the in box feed application to determine whether there is a new UI displaying on the client device (Step 525). If there is a new UI being displayed on the client device, the process 500 may return to Step 505 so that the client application may create and send a new query to the central communications system server based on the currently-displayed UI. If, instead, there is not a new UI being displayed on the client device, the client application may determine whether a given time interval, t, has passed since the last query that was sent to the central communications system server (Step 530). If the time interval, t, has not passed since the last time the UI was updated, the client application may simply return to Step 525 and continue to poll the in box feed application to determine whether there is a new UI displaying on the client device. If, instead, the time interval, t, has passed since the last time the UI was updated, the client application may simply return to Step 505 so that the client application may create and send a new query to the central communications system server based on the currently-displayed UI. It is to be understood that the exemplary method shown in flowchart 500 may also be achieved by use of a “push-based” system, too, wherein the in box feed application may push information to the client device periodically without the need for the client device to poll the server.

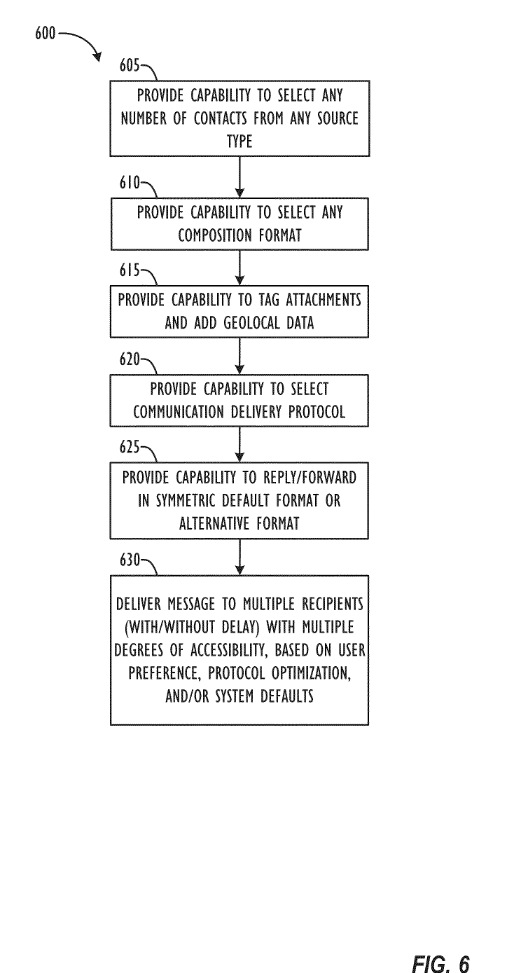

FIG. 6 shows a flowchart 600 of one embodiment of a method for creating a multi-protocol, multi-format communication transmission, according to one or more disclosed embodiments. First, the user interface of the client application may present the user with the capability to select any number of contacts from any source type (Step 605). Next, the user interface of the client application may present the user with the capability to select any composition format (Step 610). Next, the user interface of the client application may present the user with the capability to tag any desired attachments and/or geo-local data with the outgoing message (Step 615). Next, the user interface of the client application may present the user with the capability to select the desired communication delivery protocol (Step 620). Next, the user interface of the client application may present the user with the capability to reply/forward a given message in symmetric default format (i.e., the same format that the message was received in) or an alternative format (Step 625). Finally, the system may deliver the message to the selected recipient(s) in the selected/determined format(s) and via the selected/determined protocol(s) (Step 630). As described above in reference to FIG. 3E, the outgoing message format may be sent with or without delay, may have multiple degrees of accessibility, may be based on user preference, protocol optimization, and/or system defaults.

Intelligent Suppression or “Intelligent Snoozing” of Incoming Communication Notifications

Often, a user of a communication system may receive one (or a plurality) of new messages from a Sender or Senders. Sometimes, the user may not wish to view, reply, or otherwise act on that message at the time of receipt and, therefore, may select to “snooze” that message (or all communications from a particular Sender or Senders), so as to remove messages(s) from active in box view until a particular condition or conditions is met. The condition may be, e.g., a simple time-based delay, such as a delayed viewing after ten minutes have passed since the message was sent. The condition may also be based on the user's location. For example, a user may wish to snooze all messages (e.g. SMS text, voice, email, etc.) from a sender, until the user is no longer driving, has arrived at home or work, etc. Yet, another example may be device-specific. For example, messages from a particular Sender(s) may be “snoozed” until the user connects to the communication system using a different device, e.g., a device that may be more appropriate for responding to the Sender's messages.

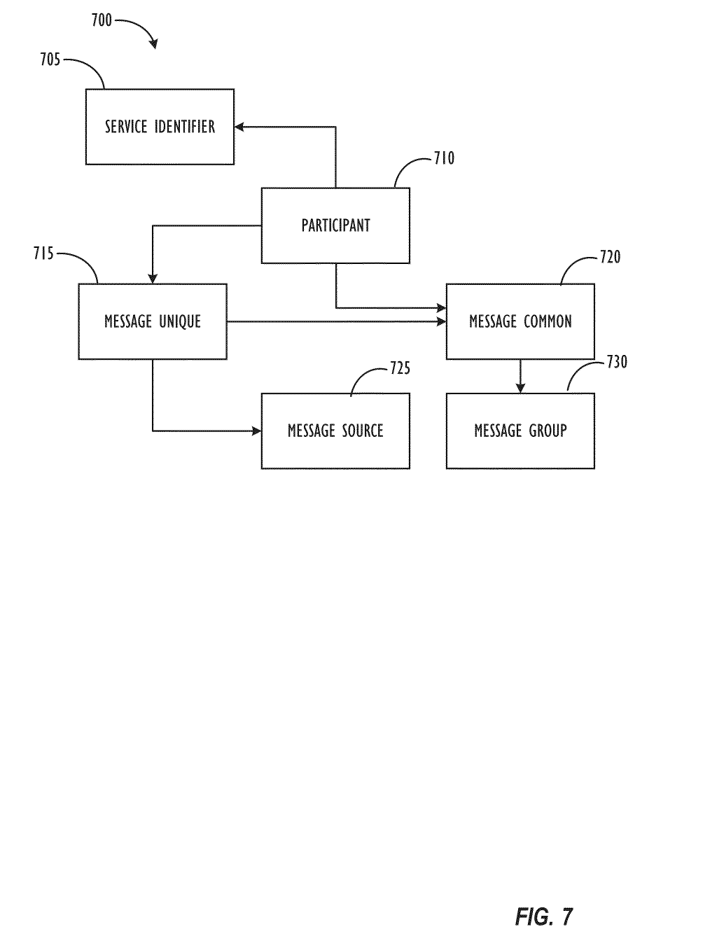

FIG. 7 shows a block diagram 700 of one embodiment of a Universal Message Object (UMO), according to one or more disclosed embodiments. The block diagram 700 describes the relationship between various components of data required to make the “Intelligent Snooze” features disclosed herein possible. It should be appreciated that the UMO facilitates not only the communication between ‘on-network’ and ‘off-network’ users, but also facilitates the backflow of updating relevant conversation histories based on the message format and communication protocol utilized.

Participant 710 objects represent an “on-network” or “off-network” users. Participant 710 objects correspond to any people identified in the traditional email format fields of “To,” “From,” “Cc,” and “Bcc.” However, the Participant 710 objects are not limited to this, as a Participant 710 may be any user engaged in the conversation, and is relational to the service being used as the underlying communication protocol.

Service Identifier 705 object represents the service utilized by a single Participant 710 object in the delivery of a format over a communication protocol. For each “To”, “From,” “Cc,” and “Bcc” associated with a message, there is a Participant 705 object containing a Service Identifier 705 indicating which service was used as the underlying format and communication protocol. The Service Identifier include data related to the delivery of the message, including the type of the service, and the address. In the case of an SMS text message, a Service Identifier 705 object would have the type of “sms” and the address would be respective telephone number. The Service Identifier 705 object implies a format and communication protocol unique to that indicated service.

Message Unique 715 is the representation format and communication protocol specific format for a message. For every message sent using the Optimal delivery method, one or more Message Unique 715 objects may be instantiated. Message Unique 715 objects contain the format and communication protocol specific data gathered during the Optimal delivery process. For example, time stamps of sent and received, based on the communication protocol are stored in the object. Additionally, in instances where the format and communication protocol are limited in some fundamental way, e.g. TWITTER® messages limited to 140 characters and SMS text message 160 character limit, it may be necessary to send multiple messages across these communication protocols to fully convey the Sender's intended message. For this purpose, multiple Message Unique 715 objects would be instantiated to track the transmitted content.

The Message Common 720 object is the message that an “on-network” user views in their in box feed. For every user message sent, there are common components present in all formats and communication protocols. For efficiency, these common components are extracted and contained in one object. Because of this efficiency, there is one Message Common 720 object for every message sent by the Sender. For example, the Message Common 720 object may store the body of the message, as well as the time sent at the moment the Sender selects ‘send,’ not the ‘sent time’ as reported by the underlying communication protocol. This has the advantage of presenting one view to the Sender and recipient(s), while resolving minor discrepancies from the underlying communication protocol.

The Message Source 725 object is a representation of the Message Unique 715 object in a Javascript object notation (JSON) format. The Message Source 725 object has a one to one relationship with the Message Unique 715 object.

Message Group 730 object is a representative identifier that coordinates a Message Common 720 object. The purpose of a Message Group 730 object is to enable multi-protocol communication and establish a relationship between those messages. There is a one to one relationship between the Message Group 730 object and the Message Common 720 object.

As multiple multi-protocol communication messages are being represented in this data model, it enables the system to truly facilitate a multi-protocol multi-format communication system. The system tracks each conversation by the Message Group 730 object relating to the Message Common 720 and then all the individual Message Unique 715 objects that relate to the Message Common 720.

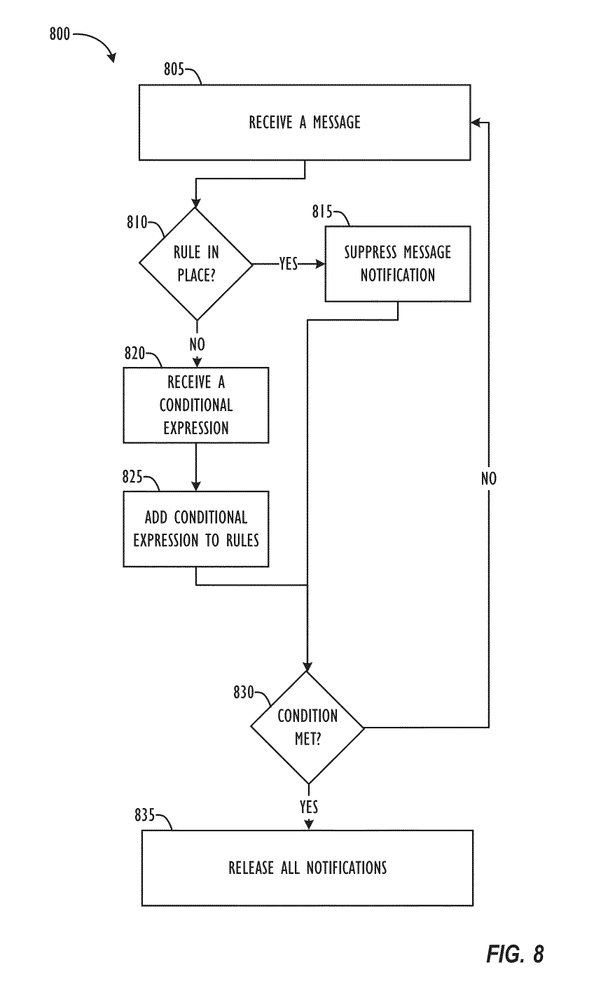

FIG. 8 shows a flowchart 800 of one embodiment of a method for intelligently suppressing, or “snoozing,” notifications from a person, according to one or more disclosed embodiments.

The flowchart 800 begins with the receiving a message 805 from a sender. The message is format-agnostic and may, e.g., be received as text, voice, image, or video. Upon reception, the message may be converted into a UMO Message Unique 715 for processing. Generally, the conversion of the message would result in a Message Common 720, as well as at least one Message Unique 715 initially. Additionally, at least two Participant 710 objects, i.e., the sender and receiver, would be extracted from this received message as well. Additional Participant 710 objects may be instantiated based on whom the message was delivered.

Upon receiving the message 805, it is determined if there is already a rule in place 810 to handle the message from that specific sender, e.g., a rule to suppress the notification of the incoming message from the specific sender to the user. As implemented, this may be a lookup for a rule set in a table or other data storage representation. A rule, as used herein, comprises a representation of conditional expressions pertaining to an individual sender or group of senders. A rule may pertain to an identified individual sender or group of senders, and may be evaluated at the point when any incoming communication from any protocol is received. Additionally, the conditional expression may comprise a conditional syntax, including, e.g., a Boolean condition. In higher level pseudocode, a conditional syntax could comprise “if-then-else” keywords. The Boolean conditions may be a single Boolean expression or multiple Boolean expressions that may be joined together by logical operators such as ‘AND’ ‘OR,’ or ‘XOR.’

If a rule pertaining to that specific sender is in place, the message notifications for that sender may be suppressed 815. When the rule pertains to a group of senders, for example, in an ongoing multi-party conversation, the Message Group 730 Object may be utilized to correlate all relevant Participant 710 objects for which the rule applies. This allows the suppression of any messages in a group communication from one or more senders in a chain or “thread” of communications.

If a rule is not in place, a message notification may be presented to the user, including the option to input a conditional expression. Upon selection, a conditional expression is received 820 by the system. Alternatively, the system may automatically generate a conditional expression. However, the conditional expression need not always be based on the received message. In UMO terms from FIG. 7, as mentioned above, the received message is represented by a Message Unique 715 object. The system rule may instead relate to a Participant 710 object extracted from the received message. This enables the “Intelligent Snooze” feature, to function as a “person-first” system, rather than a “message-first” system. Additionally, since the participant may be correlated to past communications through the UMO structure, the system has data points indicating patterns of communication for that particular sender accessible through the Participant 710 object. The data points may then be presented as input to (and applied by) a predictive time-based data model. The predictive time-based data model may then calculate an appropriate conditional expression based on those inputs. Factorization machines, support vector machines (SVM), or other machine learning techniques may be utilized to effectuate the predictive time-based data model.

Once a new conditional expression has been received, it may be added to the rules 825. This allows for the storage of new rules and for rule sets to be conveniently stored and evaluated—without prompting the user or repeated system generation of possibly duplicate conditional expressions.

Once the conditional expression has been added to the rules, to the process may then evaluate whether the condition has been met 830. This is the application of the rule to verify if the “Intelligent Snooze” of the user's notifications regarding incoming messages from Sender(s) has been lifted. This evaluation may be done with a single conditional expression or combinatory conditional expressions. For example, a Sender may be Intelligently Snoozed until the user is geo-located at home, and the time is after 9 P.M.

If the conditional expressions in the rule are not met, the flow repeats, returning to 805. In other words, when the conditional expressions in the rules have not been met, incoming messages from that Sender may continue to be “snoozed.”

If the conditional expressions in the rule have been met, on the other hand, the flow may then release all suppressed notifications 835 from that sender to the user. Effectively, the “snooze” has been lifted, and the user may again begin to receive messages and/or notifications from the sender in his in box feed. Alternatively, the flow may releases one notification that is an aggregate of some or all of the previously-suppressed messages and/or notifications.

### EXAMPLES

The following examples pertain to further embodiments. Example 1 is a non-transitory computer readable medium comprising computer executable instructions stored thereon to cause one or more processing units to receive a first message from a sender; apply a conditional expression to the first message; suppress a notification of the receipt of the first message based, at least in part, on the conditional expression not being met for the first message; and for each subsequently received message from the sender: apply the conditional expression to the respective subsequently received message from the sender; and suppress a notification of the receipt of the respective subsequently received message based, at least in part, on the conditional expression not being met for the respective subsequently received message; and release a notification of the receipt of the first message and each subsequently received message based, at least in part, on the conditional expression being met for a first subsequently received message from the sender.

Example 2 includes the subject matter of example 1, the conditional expression pertains to the sender.

Example 3 includes the subject matter of example 2, wherein the conditional expression comprises requirements based on at least one of the following: geo-location, time, calendar entries, device usage, and device activation.

Example 4 includes the subject matter of example 1, wherein the release of the notification of the receipt of the first message and each subsequently received message further comprises at least one of the following: displaying a notification of the receipt of the first message; displaying an aggregate notification for each subsequently received message; and displaying a separate notification for each subsequently received message.

Example 5 includes the subject matter of example 1, wherein the instructions to apply the conditional expression further comprise instructions to apply a predictive time-based data model.

Example 6 includes the subject matter of example 1, wherein the instructions to apply the conditional expression further comprise instructions to evaluate the conditional expression against one or more senders or recipients in a group communication.

Example 7 includes the subject matter of example 2, wherein the conditional expression comprises at least one of the following: a single Boolean expression; and multiple Boolean expressions joined together by logical operators.

Example 8 is an apparatus, comprising: a display; a memory; and one or more processing units, communicatively coupled to the memory, wherein the memory stores instructions to configure the one or more processing units to receive a first message from a sender; apply a conditional expression to the first message; suppress a notification of the receipt of the first message based, at least in part, on the conditional expression not being met for the first message; and for each subsequently received message from the sender: apply the conditional expression to the respective subsequently received message from the sender; suppress a notification of the receipt of the respective subsequently received message based, at least in part, on the conditional expression not being met for the respective subsequently received message; and release a notification of the receipt of the first message and each subsequently received message based, at least in part, on the conditional expression being met for a first subsequently received message from the sender.

Example 9 includes the subject matter of example 8, wherein the conditional expression pertains to the sender.

Example 10 includes the subject matter of example 9, wherein the conditional expression comprises requirements based on at least one of the following: geo-location, time, calendar entries, device usage, and device activation.

Example 11 includes the subject matter of example 8, wherein the release of the notification of the receipt of the first message and each subsequently received message further comprises at least one of the following: displaying a notification of receipt for the first message; displaying an aggregate notification for each subsequently received messages; and displaying a separate notification for each subsequent received message.

Example 12 includes the subject matter of example 8, wherein the instructions to apply the conditional expression further comprise instructions to apply a predictive time-based data model.

Example 13 includes the subject matter of example 12, wherein the instructions to apply the conditional expression further comprise instructions to evaluate the conditional expression against one or more senders or recipients in a group communication.

Example 14 includes the subject matter of example 8, wherein the conditional expression comprises at least one of the following: a single Boolean expression; and multiple Boolean expressions joined together by logical operators.

Example 15 is a computer-implemented method of communicating digital information, comprising: receiving a first message from a sender; applying a conditional expression to the first message; suppressing a notification of the receipt of the first message based, at least in part, on the conditional expression not being met for the first message; and for each subsequently received message from the sender: applying the conditional expression to the respective subsequently received message from the sender; and suppressing a notification of the receipt of the respective subsequently received message based, at least in part, on the conditional expression not being met for the respective subsequently received message; and releasing a notification of the receipt of the first message and each subsequently received message based, at least in part, on the conditional expression being met for a first subsequently received message from the sender.

Example 16 includes the subject matter of example 15, wherein the conditional expression pertains to the sender.

Example 17 includes the subject matter of example 16, wherein the conditional expression comprises requirements based on at least one of the following: geo-location, time, calendar entries, device usage, and device activation.

Example 18 includes the subject matter of example 16, wherein the releasing of the notification of the receipt of the first message and each subsequently received message further comprises at least one of the following: displaying a notification of the receipt of the first message; displaying an aggregate notification for each subsequently received message; and displaying a separate notification for each subsequently received message.

Example 19 includes the subject matter of example 15, wherein the act of applying the conditional expression further comprises evaluating the conditional expression against one or more senders or recipients in a group communication.

Example 20 includes the subject matter of example 16, wherein the conditional expression comprises at least one of the following: a single Boolean expression; and multiple Boolean expressions joined together by logical operators.

In the foregoing description, for purposes of explanation, numerous specific details are set forth in order to provide a thorough understanding of the disclosed embodiments. It will be apparent, however, to one skilled in the art that the disclosed embodiments may be practiced without these specific details. In other instances, structure and devices are shown in block diagram form in order to avoid obscuring the disclosed embodiments. References to numbers without subscripts or suffixes are understood to reference all instance of subscripts and suffixes corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one disclosed embodiment, and multiple references to “one embodiment” or “an embodiment” should not be understood as necessarily all referring to the same embodiment.

It is also to be understood that the above description is intended to be illustrative, and not restrictive. For example, above-described embodiments may be used in combination with each other and illustrative process steps may be performed in an order different than shown. Many other embodiments will be apparent to those of skill in the art upon reviewing the above description. The scope of the invention therefore should be determined with reference to the appended claims, along with the full scope of equivalents to which such claims are entitled. In the appended claims, terms “including” and “in which” are used as plain-English equivalents of the respective terms “comprising” and “wherein.”

What is claimed is:

1. A non-transitory computer readable medium comprising computer executable instructions stored thereon to cause one or more processing units to:
receive a first message from a sender;
apply a conditional expression to the first message;
suppress a notification of the receipt of the first message based, at least in part, on the conditional expression not being met for the first message; and
for each subsequently received message from the sender:
apply the conditional expression to the respective subsequently received message from the sender; and
suppress a notification of the receipt of the respective subsequently received message based, at least in part, on the conditional expression not being met for the respective subsequently received message; and
release a notification of the receipt of the first message and each subsequently received message based, at least in part, on the conditional expression being met for a first subsequently received message from the sender.

2. The non-transitory computer readable medium of claim 1, wherein the conditional expression pertains to the sender.

3. The non-transitory computer readable medium of claim 2, wherein the conditional expression comprises requirements based on at least one of the following: geo-location, time, calendar entries, device usage, and device activation.

4. The non-transitory computer readable medium of claim 1, wherein the release of the notification of the receipt of the first message and each subsequently received message further comprises at least one of the following: displaying a notification of the receipt of the first message; displaying an aggregate notification for each subsequently received message; and displaying a separate notification for each subsequently received message.

5. The non-transitory computer readable medium of claim 1, wherein the instructions to apply the conditional expression further comprise instructions to apply a predictive time-based data model.

6. The non-transitory computer readable medium of claim 1, wherein the instructions to apply the conditional expression further comprise instructions to evaluate the conditional expression against one or more senders or recipients in a group communication.

7. The non-transitory computer readable medium of claim 2, wherein the conditional expression comprises at least one of the following: a single Boolean expression; and multiple Boolean expressions joined together by logical operators.

8. An apparatus, comprising:
a display;
a memory; and
one or more processing units, communicatively coupled to the memory, wherein the memory stores instructions to configure the one or more processing units to:
receive a first message from a sender;
apply a conditional expression to the first message;
suppress a notification of the receipt of the first message based, at least in part, on the conditional expression not being met for the first message; and
for each subsequently received message from the sender:
apply the conditional expression to the respective subsequently received message from the sender;
suppress a notification of the receipt of the respective subsequently received message based, at least in part, on the conditional expression not being met for the respective subsequently received message; and
release a notification of the receipt of the first message and each subsequently received message based, at least in part, on the conditional expression being met for a first subsequently received message from the sender.

9. The apparatus of claim 8, wherein the conditional expression pertains to the sender.

10. The apparatus of claim 9, wherein the conditional expression comprises requirements based on at least one of the following: geo-location, time, calendar entries, device usage, and device activation.

11. The apparatus of claim 8, wherein the release of the notification of the receipt of the first message and each subsequently received message further comprises at least one of the following: displaying a notification of receipt for the first message; displaying an aggregate notification for each subsequently received messages; and displaying a separate notification for each subsequent received message.

12. The apparatus of claim 8, wherein the instructions to apply the conditional expression further comprise instructions to apply a predictive time-based data model.

13. The apparatus of claim 12, wherein the instructions to apply the conditional expression further comprise instructions to evaluate the conditional expression against one or more senders or recipients in a group communication.

14. The apparatus of claim 8, wherein the conditional expression comprises at least one of the following: a single Boolean expression; and multiple Boolean expressions joined together by logical operators.

15. A computer-implemented method of communicating digital information, comprising:
receiving a first message from a sender;
applying a conditional expression to the first message;
suppressing a notification of the receipt of the first message based, at least in part, on the conditional expression not being met for the first message; and
for each subsequently received message from the sender:
applying the conditional expression to the respective subsequently received message from the sender; and
suppressing a notification of the receipt of the respective subsequently received message based, at least in part, on the conditional expression not being met for the respective subsequently received message; and
releasing a notification of the receipt of the first message and each subsequently received message based, at least in part, on the conditional expression being met for a first subsequently received message from the sender.

16. The computer-implemented method of claim 15, wherein the conditional expression pertains to the sender.

17. The computer-implemented method of claim 16, wherein the conditional expression comprises requirements based on at least one of the following: geo-location, time, calendar entries, device usage, and device activation.

18. The computer-implemented method of claim 15, wherein the releasing of the notification of the receipt of the first message and each subsequently received message further comprises at least one of the following: displaying a notification of the receipt of the first message; displaying an aggregate notification for each subsequently received message; and displaying a separate notification for each subsequently received message.

19. The computer-implemented method of claim 15, wherein the act of applying the conditional expression further comprises evaluating the conditional expression against one or more senders or recipients in a group communication.

20. The computer-implemented method of claim 16, wherein the conditional expression comprises at least one of the following: a single Boolean expression; and multiple Boolean expressions joined together by logical operators.
